(19) United States
(12) Patent Application Publication
(10) Pub. No.: US 2011/0162901 A1
(43) Pub. Date: Jul. 7, 2011

(54) COOLING AIR DUCT FOR ELECTRIC VEHICLE

(75) Inventors: Marc Jonathon Lucas, Novi, MI (US); Mark G. Smith, Canton, MI (US); Brian Scott Scensny, Macomb Township, MI (US)

(73) Assignee: FORD GLOBAL TECHNOLOGIES, LLC, Dearborn, MI (US)

(21) Appl. No.: 12/730,368

(22) Filed: Mar. 24, 2010

(51) Int. Cl. B60K 11/00; B60H 1/34; F24F 7/007

(52) U.S. Cl. 180/68.2; 454/152; 454/338

(57) ABSTRACT

A vehicle having a front seating row, a rear seating row, and an electric compartment located behind an/or beneath the rear seating row has a duct extending forward from the electric compartment. The duct carries air exiting the electric compartment toward a HVAC system intake located forward of the front seating row. The air from the electric compartment may thus be drawn through the HVAC system for cooling before being returned to the passenger cabin, yielding improvements in both electrical equipment cooling and passenger comfort.

### BACKGROUND

1. Technical Field

The present invention relates generally to electrically-powered automotive vehicles having air-cooled electrical components, and more specifically to a cooling air duct arrangement providing improved cooling and vehicle occupant comfort.

2. Background Art

Some electrically-powered vehicles, including hybrid-electric vehicle (HEVs), plug-in HEVs, pure electric vehicles, etc., have batteries and/or other electric components located in an equipment compartment in or adjacent to the passenger cabin and/or cargo compartment of the vehicle. Electric equipment compartments are typically located beneath and/or behind one or more of the occupant seating positions, below the passenger or cargo compartment floor, behind trim panels, and/or beneath one or more of the seats. Electric components, particularly high-voltage components, typically generate a significant amount of heat during operation and so may require some degree of active cooling. This cooling is, in many cases, accomplished by providing a relatively constant flow of ambient air from within the vehicle passenger cabin.

In one conventional vehicle layout, the electric compartment is located directly behind an occupant seating row. A fan or other air movement device draws air into the electric compartment through one or more inlets, typically located above the compartment, and heated exhaust air is expelled into the passenger cabin and/or cargo compartment at one or more locations. In some cases the exhaust air may be ducted or otherwise directed toward air extractors, which are commonly located in the trunk or rear cargo area.

In a vehicle having two or more seating rows, if both the intake and exhaust ducts of the electric compartment are located near the rear seating row, at least a portion of the heated exhaust air may find its way back to the inlet for recirculation. Heated exhaust air directed toward a trunk or rear cargo area may rise and find its way into the passenger cabin. This has a degrading effect on the effectiveness of cooling of the equipment in the electric compartment. In addition, if the intake is at a relatively high position in the passenger cabin, for example directly behind the headrest of the rear seating row, this recirculation of warm exhaust air may make the rear seating row uncomfortably warm for the seat occupant. This warming effect will be particularly noticeable when the vehicle HVAC (Heating, Ventilation, and Air Conditioning) system is in a “recirculate” mode in which fresh air from outside the vehicle is not drawn into the vehicle.

### SUMMARY

According to a disclosed embodiment, an electric-powered vehicle has a front seating row, a rear seating row, an electric compartment located adjacent to the rear seating row, and an HVAC system intake forward of the front seating row. A duct carries cooling air from the electric compartment and has an outlet in fluid communication with the HVAC system intake. Thus the air from the electric compartment may be drawn through the HVAC system and returned to the passenger cabin far from the electric compartment intake thereby improving passenger comfort. Further, the air conditioning system may be used to cool the air before it is returned to the cabin, providing improvements in both electrical equipment cooling and passenger comfort.

According to a further feature of the disclosed embodiments, a wiring bundle connecting electrical equipment in the electric compartment with a drivetrain component located forward of the front seating row extends through a portion of the duct. Utilizing the duct as a pathway for both air and the wiring is an efficient use of space in the vicinity of the passenger cabin.

According to another feature of the disclosed embodiments, the air duct passes beneath the front seating row.

According to a another feature of the disclosed embodiments, a vehicle having an electric compartment located behind and/or beneath a seating row, an electric drivetrain component located forward of the seating row, and an HVAC system inlet located forward of the seating row, comprises a duct having an inlet receiving air exiting the electric compartment and an outlet adjacent the HVAC system intake. A wiring bundle extends between the electric compartment and the electric drivetrain component, the wiring bundle passing through the duct.

Other features of the embodiments will be apparent from the following description of embodiments.

### BRIEF DESCRIPTION OF THE DRAWINGS

Embodiments of the present invention will now be described by way of example only with reference to the accompanying drawings in which:

FIG. 1 is a simplified schematic diagram of a passenger vehicle having an air duct in accordance with an embodiment of the present invention; and

FIG. 2 is a simplified cross-sectional view of an air duct including a wiring bundle passageway;

FIG. 3 is a simplified schematic view of a vehicle having an air duct according to a second embodiment of the invention; and

FIG. 4 is a simplified schematic diagram of a vehicle having an air duct in accordance with a third embodiment of the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

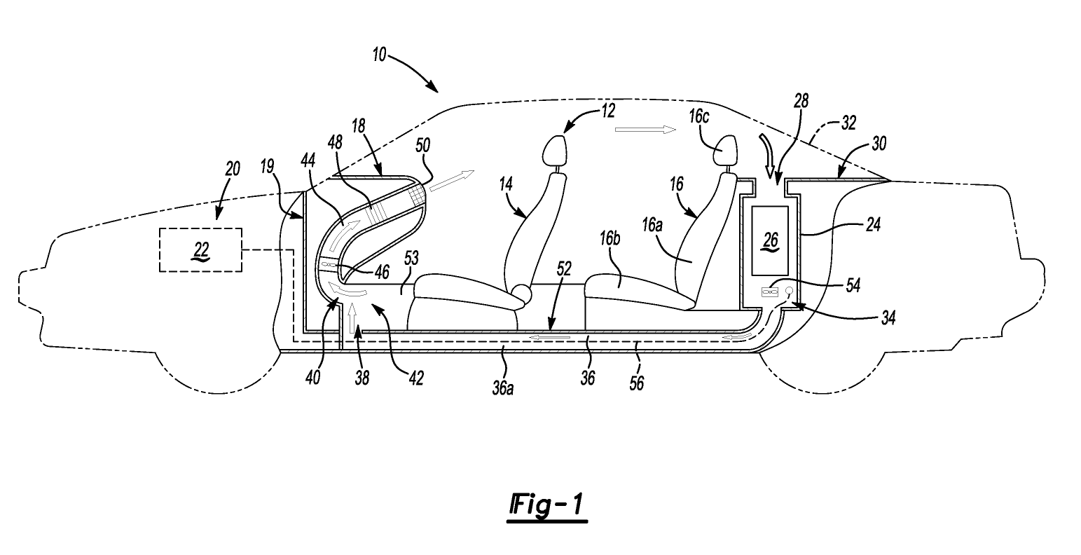

Referring to FIG. 1, an electric-powered vehicle 10 includes a passenger cabin 12 in which a front seating row 14 and a rear seating row 16 are arranged. Seating rows 14, 16 may each be a single seat or multiple seats arranged across the width of the vehicle. An instrument panel 18 is located in front of front seating row 14 in the conventionally known manner. A dash panel 19 separates instrument panel 18 from a forward drivetrain compartment 20 containing electric and/or hybrid/electric drivetrain components, such as an electric traction motor 22. Forward drivetrain compartment 20 may also contain components such as a heater, air conditioning compressor, inverters, converters, and a power steering motor or pump (not shown), as is well known in the art.

An electric compartment 24 is located behind rear seating row 16. The term electric compartment is defined herein to mean a compartment that contains electrical equipment 26 associated with the drive system of an electric-powered vehicle. Electrical equipment 26 may comprise, as is well known in the electric and hybrid/electric vehicle arts, one or more batteries, battery chargers, converters (DC/DC, AC/DC, and/or DC/AC), and/or inverters. Electric compartment 24 is shown located immediately behind a seatback 16a of rear seating row 16, but may alternatively be partially or completely below the seat cushion 16b of the seating row, as determined by vehicle layout and packaging constraints. A cooling air inlet 28 is located adjacent the upper end of electric compartment 24, for example in the “package shelf” area 30 between a headrest 16c and a rear window 32.

An exhaust opening 34 is located adjacent the lower portion of electric compartment 24 and communicates with a duct 36 that extends forward through the passenger cabin 12. Duct 36 includes a forward portion 36a that extends beneath, between, and/or around the seating positions of front seating row 14 and has an outlet 38 in fluid communication with an HVAC system intake 40. The term “fluid communication” as used herein means that outlet 38 is located adjacent and/or forward of front seating row 14 to direct the air exiting the outlet into HVAC system intake 40. In the embodiment shown, HVAC system intake 40 is located adjacent a lower portion of instrument panel 18, for example in a footwell area 42 forward of front seating row 14. Air from passenger cabin 12 and/or outlet 38 is drawn into HVAC system intake 40 and through an HVAC duct 44 by a circulation fan 46.

Air passing through the HVAC duct 44 may be cooled, when appropriate, by an air conditioning heat exchanger 48 before being returned to the passenger cabin and/or cargo compartment through vents 50. HVAC vents may be located in any number of positions throughout the vehicle cabin, vents 50 being shown in the upper portion of instrument panel 18 only as an example. The HVAC system may also include other components such as a heater and/or a fresh/recirculate door that, as is well know in the automotive HVAC art, is movable to control the amount and proportion of fresh, outside air versus recirculated cabin air that is drawn into the HVAC system.

Duct 36 may be located below a passenger cabin floor 52, as shown in FIG. 1, or may otherwise be integrated with portions of the passenger cabin structure. For example, duct 36 may be located on top of floor 52, or it may pass through or be integrated with a console 53 located between two seats or seating positions in a seating row, or it may extend behind or be integrated with a console, arm rest, or other trim panels (not shown) located outboard of a seating position. Duct 36 may have additional air inlet openings (not shown) located between exhaust opening 34 and outlet 38 if desired to allow air from the passenger cabin to be drawn into the duct and delivered to HVAC duct 44.

The rate of air flow through electric compartment 24 and into duct 36 may be controlled by an exhaust fan 54. Exhaust fan 54 may be located in or adjacent to electric compartment 24 or it may be located at any point in or along duct 36 where it is able to control the air flow.

As mentioned above, outlet 38 is located to direct the warm exhaust air from electric compartment 24 toward HVAC system intake 40. When circulation fan 46 is operating the exhaust air will be drawn into HVAC duct 44 and, if the HVAC system is operating in a cooling mode, the air will be cooled by AC heat exchanger 48 before being returned to cabin 12 through vents 50. The cooling of the electric compartment exhaust air, combined with the fact that the air is returned to cabin 12 relatively far from rear seating row 16 and cooling air inlet 28, results in improved cooling of the electrical compartment 24. It also eliminates the tendency of the warm exhaust air accumulating and recirculating near rear seating row 16, thereby improving the comfort of rear seating row passenger(s). Both of these results are particularly noticeable and important if the HVAC system is operating in a “recirculate” mode.

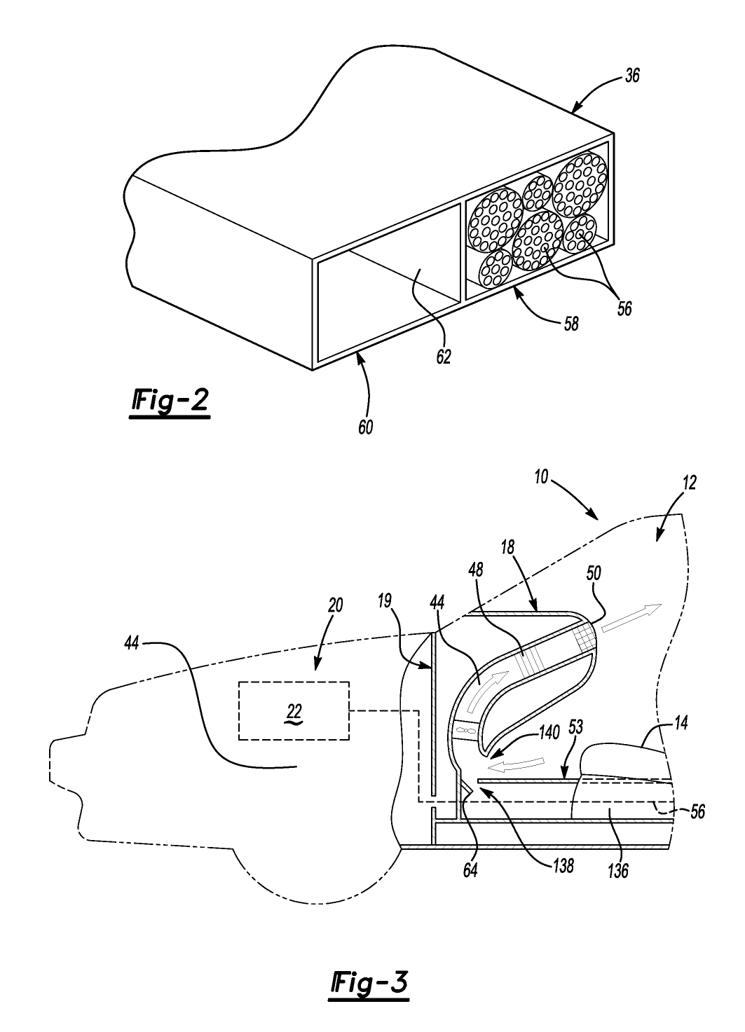

According to a further feature of the disclosed embodiment, an electric wiring bundle, schematically indicated by reference numeral 56 in FIG. 1, extends between electric compartment 24 and forward drivetrain compartment 20. Wiring bundle 56, as is well known in the electric/HEV arts, transfers electrical power from the electrical equipment 26 to electric motor 22 and/or other drivetrain components located in or near forward drivetrain compartment 20. As seen in FIG. 2, duct 36 may be divided into a wiring channel 58, through which wiring bundle 56 runs, and an air passageway 60 by a separating wall 62. Duct 36 may comprise any number of separate passageways and/or channels for conducting air and one or more wiring bundles 56. Duct 36 may be produced by a plastic extrusion process, or by other known manufacturing techniques.

Air passageway 60 preferably terminates adjacent outlet 38 so that substantially all of the exhaust air is vented into passenger cabin 12. Wiring channel 58 may extend forward of outlet 38 so that wiring bundle 56 may be routed forward of dash panel 19 and into drivetrain compartment 20 to make connection with drivetrain components 22. One or more seals (not shown) may be located where duct 36 passes through instrument panel 18 and/or dash panel 19 so that substantially all of the air flowing through air passageway 60 is directed through or towards outlet 38 rather than passing into drivetrain compartment 20.

FIG. 3 shows an embodiment of the invention in which a duct 136 extends through a console 53 passing between the left and right seats of front seating row 14. Duct 136 has an outlet 138 that communicates more directly with HVAC duct 44 than is the case in the embodiment of FIG. 1. Electric compartment cooling airflow is drawn into HVAC duct 44 without first being directed into footwell 42. Cabin air is drawn into HVAC duct 44 through HVAC inlet 140. A cooling air baffle door 64 may be provided adjacent outlet 138 and/or adjacent HVAC inlet 140. Cooling air baffle door 64 is movable between open and closed positions by, for example, an electric motor, to control the amounts of electric compartment cooling air allowed to exit duct 136 through opening 138. In the embodiment depicted, baffle door 64 is hinged about its left/forward end. The position of the door 64 may be controlled by a control module (not shown) that balances the passenger cabin climate and electric compartment cooling needs.

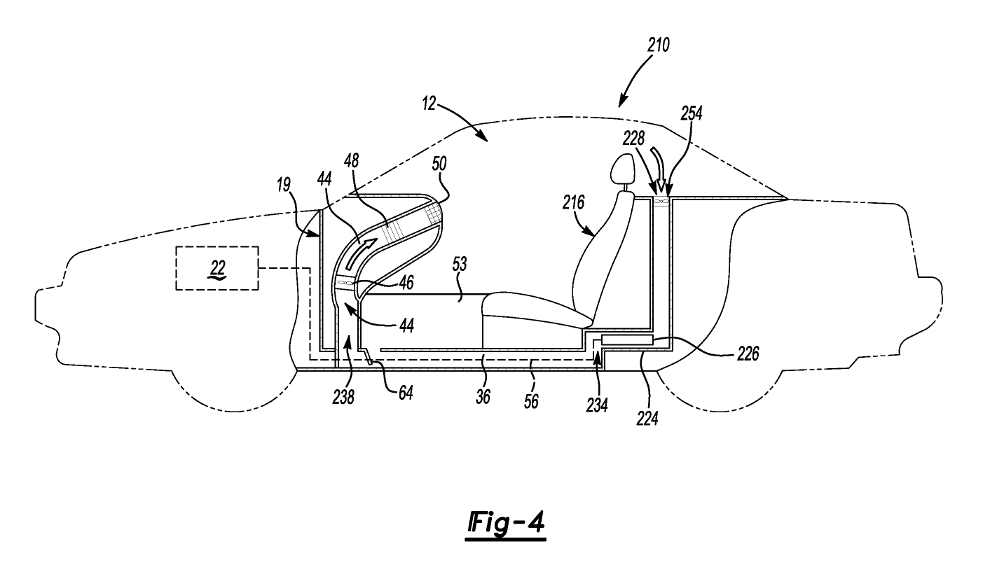

FIG. 4 shows a vehicle 210 having a single seating row 216, which may comprise a single seat or multiple seats side-by-side. In this embodiment, electric compartment 224 is located partially beneath seating row 216 and is supplied with cooling air through an inlet 228. The flow of cooling air may be increased or otherwise controlled by a fan 254. Air exits electric compartment 224 via exhaust outlet 234, travels though duct 36 extending forward from the electric compartment, and passes through outlet 238 into HVAC duct 44. In this embodiment, there is no intake opening through which air may flow from the footwell directly into HVAC duct 44. A movable baffle door 64 may be provided to control the amount of electrical cooling air entering HVAC duct 44 from duct 36. Wire bundle 56 connects electrical equipment 226 with electric drivetrain component 22, passing through duct 36.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. Apparatus for an electric-powered vehicle having a passenger cabin with a front and a rear seating row and an electric compartment adjacent the rear seating row comprising:
a HVAC system intake forward of the front seating row; and
a duct extending from the electric compartment and conducting air from the electric compartment though the passenger cabin, the duct including a forward portion having an outlet in fluid communication with the HVAC system intake.

2. The apparatus according to claim 1 wherein the duct passes beneath the front seating row.

3. The apparatus according to claim 1 wherein the duct passes alongside a seating position of the front seating row.

4. The apparatus according to claim 1 further comprising a wiring bundle connected to equipment in the electric compartment and to an electric drivetrain component located forward of the front seating row, the wiring bundle extending through a portion of the duct.

5. The apparatus according to claim 4 wherein the duct comprises an air passage and a wiring bundle passage separated by a dividing wall.

6. The apparatus according to claim 1 wherein the duct outlet is located adjacent to a footwell forward of the front seating row and the HVAC system intake is located in the footwell.

7. The apparatus according to claim 1 further comprising a fan forcing the air through the duct from the electric compartment to the HVAC system intake.

8. An electric-powered vehicle having front and rear seating rows and comprising:
a ventilated electric compartment located adjacent to the rear seating row and containing at least one electrical component;
a HVAC system having an intake located forward of the front seating row; and
a duct having an inlet end receiving air exiting the electric compartment and an outlet end located forward of the front seating row and directing the air toward the HVAC system intake.

9. The vehicle according to claim 8 wherein the duct passes beneath the front seating row.

10. The vehicle according to claim 8 wherein the duct passes alongside a seating position of the front seating row.

11. The vehicle according to claim 8 further comprising:
an electric drivetrain compartment located forward of the front seating row; and
a wiring bundle extending between the electric compartment and the electric drivetrain compartment, the wiring bundle passing through a portion of the duct.

12. The vehicle according to claim 11 wherein the duct comprises an air passage and a wiring bundle passage separated by a dividing wall.

13. The vehicle according to claim 8 wherein the duct has an air outlet opening located adjacent to a footwell forward of the front seating row and the HVAC system intake is located in the footwell.

14. The vehicle according to claim 8 further comprising a fan forcing the air through the duct from the electric compartment to the HVAC system intake.

15. Apparatus for an electric-powered vehicle having an electric compartment located behind and/or beneath a seating row, an electric drivetrain component located forward of the seating row, and an HVAC system inlet located forward of the seating row, the apparatus comprising:
a duct having an air passageway receiving air from the electric compartment and conducting the air to an outlet adjacent the HVAC system intake, and a wiring channel extending between the electric compartment and the electric drivetrain component.

16. The apparatus according to claim 15 wherein the duct passes beneath the seating row.

17. The apparatus according to claim 15 wherein the duct passes alongside a seating position of the seating row.

18. The apparatus according to claim 15 wherein duct is an extruded plastic component comprising a dividing wall separating the air passageway and the wiring channel.

19. The apparatus according to claim 15 wherein the outlet is located adjacent a footwell forward of the seating row and the HVAC system intake is located in the footwell.

20. The apparatus according to claim 15 further comprising a fan forcing the air through the duct from the electric compartment to the HVAC system intake.
